(19) United States
(12) Patent Application Publication
(10) Pub. No.: US 2022/0172876 A1
(43) Pub. Date: Jun. 2, 2022

(54) Magnetic Core Assembly, Electronic Device and Manufacturing Method For A Magnetic Core Assembly

(71) Applicant: Flex Ltd., Singapore (SG)

(72) Inventors: Guoqiang ZHOU, Shenzhen (CN); Bruce TANG, Shenzhen (CN)

(73) Assignee: Flex Ltd., Singapore (SG)

(21) Appl. No.: 17/244,351

(22) Filed: Apr. 29, 2021

(30) Foreign Application Priority Data
Nov. 30, 2020 (CN) 202011386677.5

(51) Int. Cl. H01F 27/255; H01F 27/28; H01F 1/147; H01F 41/02; H01F 1/34

(52) U.S. Cl. CPC H01F 27/255; H01F 27/28; H01F 1/34; H01F 41/0246; H01F 1/147

(57) ABSTRACT

A magnetic core assembly includes a first core having at least one gap and at least one second core provided within the at least one gap of the first core. The first core and the at least one second core are made of different materials. The at least one second core occupies a space no larger than the at least one gap of the first core.

### CROSS REFERENCE TO RELATED APPLICATION

The present application claims the benefit of and priority to Chinese Patent Application No. 202011386677.5 filed Nov. 30, 2020, and entitled “MAGNETIC CORE ASSEMBLY, ELECTRONIC DEVICE AND MANUFACTURING METHOD FOR A MAGNETIC CORE ASSEMBLY,” the entire disclosure of which is hereby incorporated by reference for all that it teaches and for all purposes.

### FIELD

The present disclosure is generally directed to a magnetic core assembly, and more particular to a magnetic core assembly, an inductor and a transformer including the same, and a fabrication process thereof.

### BACKGROUND

Magnetic elements such as inductors or transformers are widely used in switch-mode power converters. Recently, there is a trend towards incorporating high frequency switching in the power converters. With high frequency switching, for an equivalent “ON/OFF” voltage and ripple current, the frequency ∝1/inductance, the cost for the switch-mode power converters can be reduced and the efficiency can be increased. There are, however, several drawbacks to incorporating high frequency switching in related art power converters that affect power density, efficiency, losses and reliability in these devices.

### SUMMARY

At least one example embodiment is directed to a magnetic core assembly. The magnetic core assembly includes a first core having at least one gap and at least one second core provided within the at least one gap of the first core. The first core and the at least one second core are made of different material s. Moreover, the at least one second core occupies a space no larger than the at least one gap of the first core.

At least one example embodiment is directed to an electronic device. The electronic device includes a magnetic core and a coil wound around the magnetic core. The magnetic core includes a first core having at least one gap and at least one second core provided within the at least one gap of the first core. The first core and the at least one second core are made of different materials. Moreover, the at least one second core occupies a space no larger than the at least one gap of the first core.

At least one example embodiment is directed to a manufacturing method for a magnetic core assembly. The manufacturing method for a magnetic core assembly includes providing a first core with at least one gap and positioning at least one second core within the at least one gap of the first core. The first core and the at least one second core are made of different materials. Moreover, the at least one second core occupies a space no larger than the at least one gap of the first core.

### BRIEF DESCRIPTION OF THE DRAWINGS

FIG. 1 is a graph illustrating the open circuit inductance (OCL) versus the saturation current (Isat) curve for a magnetic core having a ferrite core and a magnetic core having a ferrite core combined with a metal powder core in accordance with embodiments of the present disclosure;

FIG. 2 shows a table comparing a magnetic core having a ferrite core with a magnetic core having a ferrite core combined with a metal powder core in accordance with embodiments of the present disclosure;

FIG. 3 illustrates a comparison of a ferrite core and plate as a gap with a metal powder material—NPA core as a gap according to one embodiment of the present disclosure;

FIG. 4A is a block diagram of an inverter as a conventional coupled output choke;

FIG. 4B is a block diagram of an inverter as a coupled output choke according to an embodiment of the present disclosure;

FIG. 5A is a block diagram of a transformer used in a conventional interleaved power factor converter (PFC) booster converter circuit;

FIG. 5B is a block diagram of a transformer used in an interleaved PFC booster converter circuit according to an embodiment of the present disclosure; and

FIG. 6 is a flowchart of a manufacturing method for a magnetic core assembly in accordance with embodiments of the present disclosure.

### DETAILED DESCRIPTION

Embodiments of the present disclosure will be described in connection with a magnetic core assembly, an inductor and a transformer including the same, and a fabrication process thereof. The magnetic core used for inductors and transformers may be classified into two types: a metal powder core and a ferrite core. The metal powder core is a core made of a powder-typed compound metal. The metal powder core has a low permeability and a superior current characteristic but is expensive. On the other hand, the ferrite core is cheap and superior in high frequency characteristics and loss characteristics but has a high magnetic permeability. The magnetic core for the inductor and transformer is typically made of metal having a high magnetic permeability and provided inside of coils made of a conductive wire to assist in a magnetic flux or a magnetic field being formed.

Inductors are generally used as chokes in high current output choke and direct current (DC)/DC converters and transformers are generally used in interleaved power factor converter (PFC) boost converter circuits operating in the continuous conduction mode (CCM), the discontinuous conduction mode (DCM) and the critical conduction mode (CrCM). With high frequency switching, the magnetic core characteristics for inductors and transformers include the frequency defined to be in the range of 500 kHz to 100 MHz, a high saturation flux density (Bsat) to avoid saturation at high DC bias, a low permeability which forces increased turns and reduces alternating current (AC) flux density, little or no discrete gaps which reduces fringing effects, a single layer winding which reduces proximity effect losses, low losses with respect to Eddy currents and good inductance linearity with frequency and power.

As stated above, the ferrite core is cost-effective and has low power consumption of the core. Since the saturation flux density of ferrite is low, an air gap and a Litz wire are necessary. In such situations, the overall volume of the core is relatively large. One ferrite material used for the ferrite core is manganese-zinc (Mn—Zn). Mn—Zn materials lose effectiveness at greater than 1 MHz due to low bulk resistivity. Also, Mn—Zn materials require discrete gaps to reduce effective permeability (gap losses), have a low saturation flux density (Bsat<0.5 T at 100° C.) and a temperature limitation of (<100° C.).

The metal powder cores, such as magnetism powder cores are distributed air gap cores made from ferrous alloy powders for low losses at high frequencies. Small air gaps distributed evenly throughout the cores increase the amount of DC that can be passed through the winding before core saturation occurs. Metal powder cores have a high saturation flux density (Bsat>0.9 T at 100° C.), a distributed air gap which means lower permeability and not discrete air gaps, low hysteresis and Eddy current loss, effectiveness greater than 100 MHz and a temperature limitation of (<100° C.).

According to one embodiment of the present disclosure, a ferrite core and a metal powder core are combined to enhance the benefits of the magnetic core for the inductors and transformers as discussed in greater detail below.

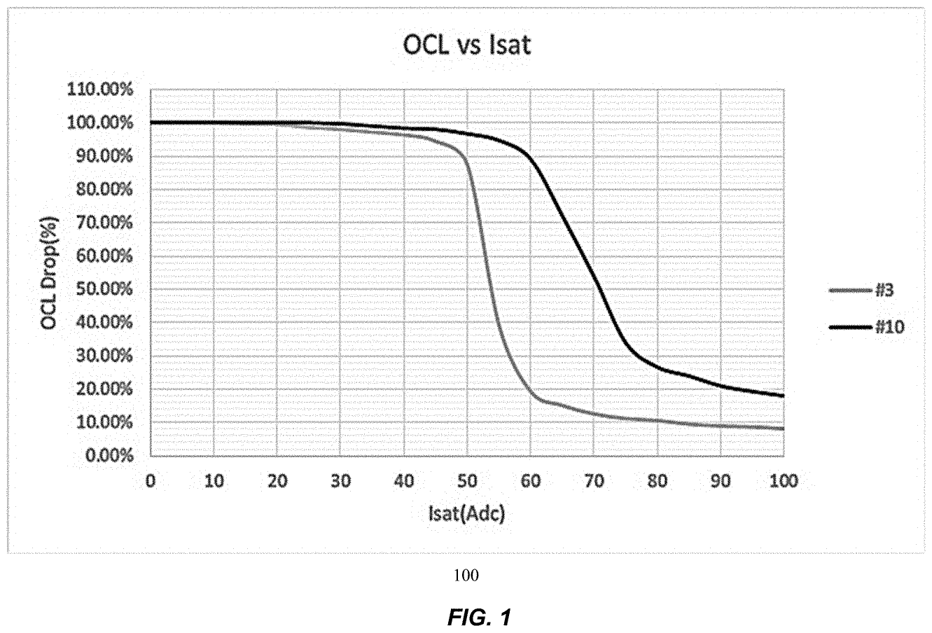

Metal powder cores such as iron powder material cores include, but are not limited to carbonyl iron, nanoparticle array (NPA) iron-silicide (Fe—Si 3.0) powder cores, molypermalloy powder (MPP) Ni—Fe—Mo alloy cores, High Flux Fe—Ni alloy cores and Sendust/Kool Mu® Fe—Si—Al alloy cores. According to one embodiment of the present disclosure, iron powder materials such as a NPA iron-silicide (Fe—Si 3.0) powder cores, MPP Ni—Fe—Mo alloy cores, High Flux Fe—Ni alloy cores and Sendust/Kool Mu® Fe—Si—Al alloy cores are combined with a ferrite core using materials such as Mn—Zn type materials. This combination yields a Bsat over 950 mT which enhances the Bsat of 600 mT when the Mn—Zn material is used alone. The combination also provides an enhance saturation current (Isat) (over 20%˜30% than the Mn—Zn material used alone) as illustrated in FIG. 1.

FIG. 1 is a graph illustrating the open circuit inductance (OCL) versus Isat curve for a magnetic core having a ferrite core and a magnetic core having a ferrite core combined with a metal powder core in accordance with embodiments of the present disclosure. In graph 100, the vertical axis represents the OCL measured in percentage (%) and the horizontal axis represents the Isat measured in DC amperage (Adc). Graph 100 plots two magnetic cores. The first magnetic core labeled core #3 includes a ferrite core of Mn—Zn with an inductance of 3.8 μH with three turns (3TS) and the second magnetic core labeled core #10 includes a ferrite core of Mn—Zn combined with an iron powder core NPA with an inductance of 3.0 μH and three turns (3TS). As illustrated in graph 100, the Isat of core #10 has a 20% to 30% increase over core #3.

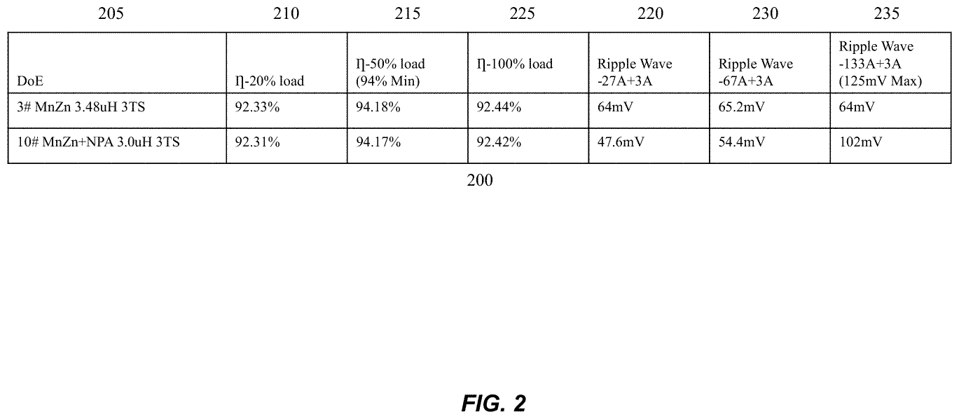

FIG. 2 shows a Table 200 comparing magnetic core #3 having a ferrite core with a magnetic core #10 having a ferrite core combined with a metal powder core in accordance with embodiments of the present disclosure. Table 200 includes Column 205 representing the design of experiment (DoE), Column 210 representing η-20% of the load (20% power), Column 215 representing η-50% of the load (50% power), Column 220 representing η-100% of the load (100% power), Column 225 representing the ripple wave of 27 A+3 A, column 230 representing the ripple wave of 67 A+3 A and Column 235 representing the ripple wave of 133 A+3 A (125 mV Max). As indicated in Table 200, magnetic core #10 is only slightly less than magnetic core #3 for η-20%, η-50% and η-100% of the load which indicates that the efficiency of both magnetic cores are substantially the same (with the standard being 94%) without changing the dimensions of the magnetic core. Moreover, as indicated in Table 200, for the ripple waves for Columns 225 and 230, magnetic core #10 is less than magnetic core #3 while the ripple wave for Column 235 for magnetic core #10 is greater than magnetic core #3. Therefore, with magnetic core #10, the ripple wave issues at 133+3 A (102 mV) with the standard being 125 mV maximum and peak load issues are settled, whereas with the magnetic core #3, the ripple wave issues at 133+3 A (133 mv) and peak load issues still exist.

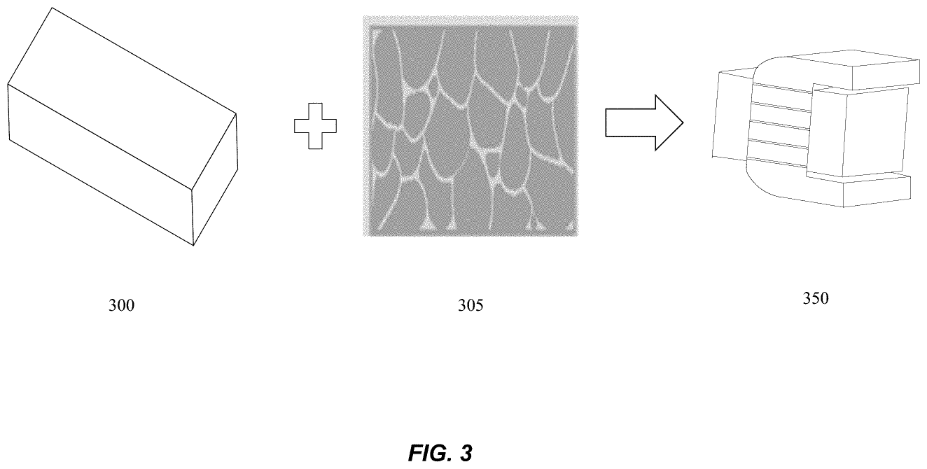

FIG. 3 illustrates a comparison of a ferrite core and plate as a gap with a metal powder material—NPA core as a gap according to one embodiment of the present disclosure. As illustrated, the metal powder material (NPA) core 300 includes a distributed gap 305. The Mn—Zn core and FR4 plate 340 includes discrete air gaps. With the distributed gap 305, discrete air gaps are not required which results in settling magnetic hysteresis loss issues and decreasing copper losses due to reduced fringing losses and hysteresis losses.

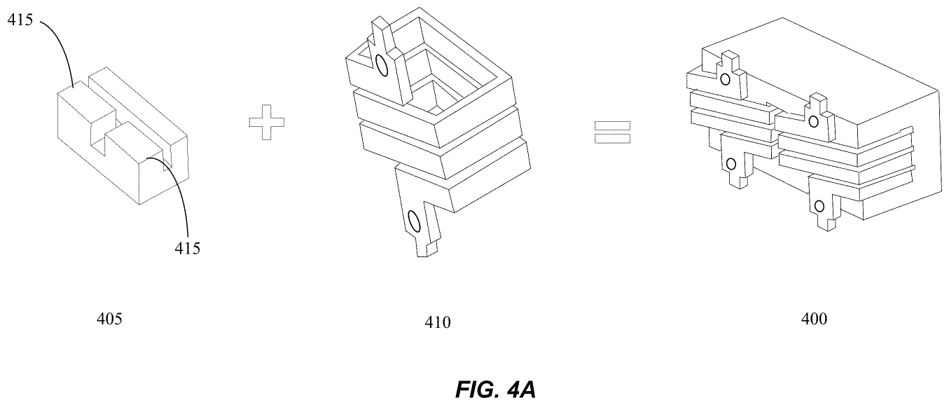

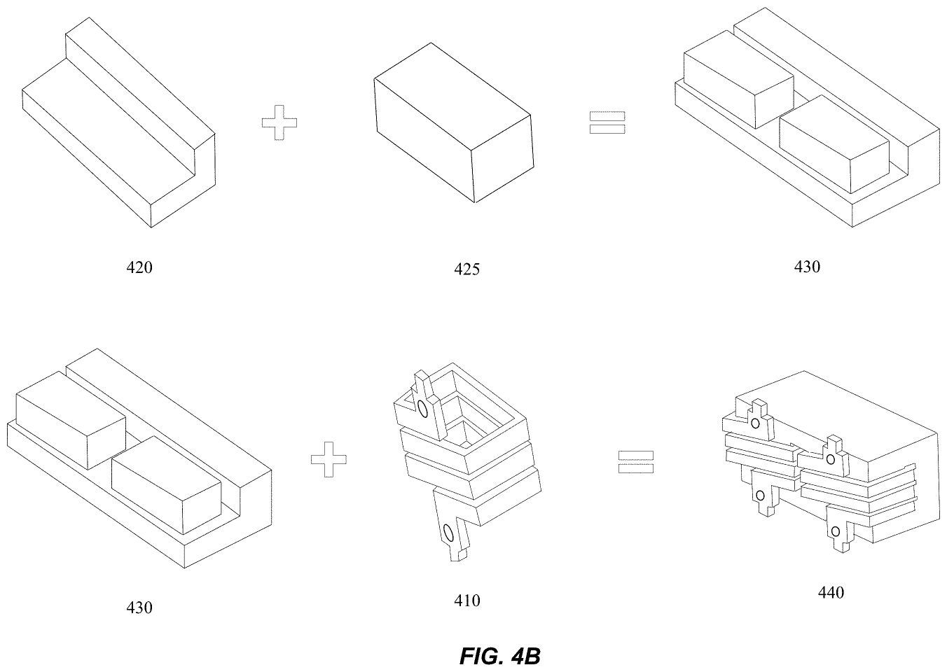

FIG. 4A is a block diagram of an inverter as a conventional coupled output choke. As illustrated in FIG. 4A, the conventional coupled output choke 400 is the combination of ferrite core 405 and copper winding 410. Ferrite core 405 may include for example a Mn—Zn core. Although not illustrated in FIG. 4A, ferrite core 405 includes gaps. The gaps are filled with blocking gaps 415 which are made with the same material as ferrite core 405.

FIG. 4B is a block diagram of an inverter as a coupled output choke according to an embodiment of the present disclosure. As illustrated in FIG. 4B, the coupled output choke 440 is the combination of the ferrite core 420, the metal powder core 425 and the copper winding 410. As illustrated in FIG. 4B, the ferrite core 420 includes gaps provided on one side of the ferrite core 420. Metal powder cores 425 are positioned to occupy the gaps of ferrite core 420. The metal powder cores 425 occupy a space no larger than the gap of the ferrite core 420. Although two metal powder cores 425 are illustrated in the figure to accommodate within the gap of the ferrite core 420, more or fewer metal powder cores 425 can be used to be accommodated within the gap of the ferrite core 420 without departing from the spirit and scope of the present disclosure.

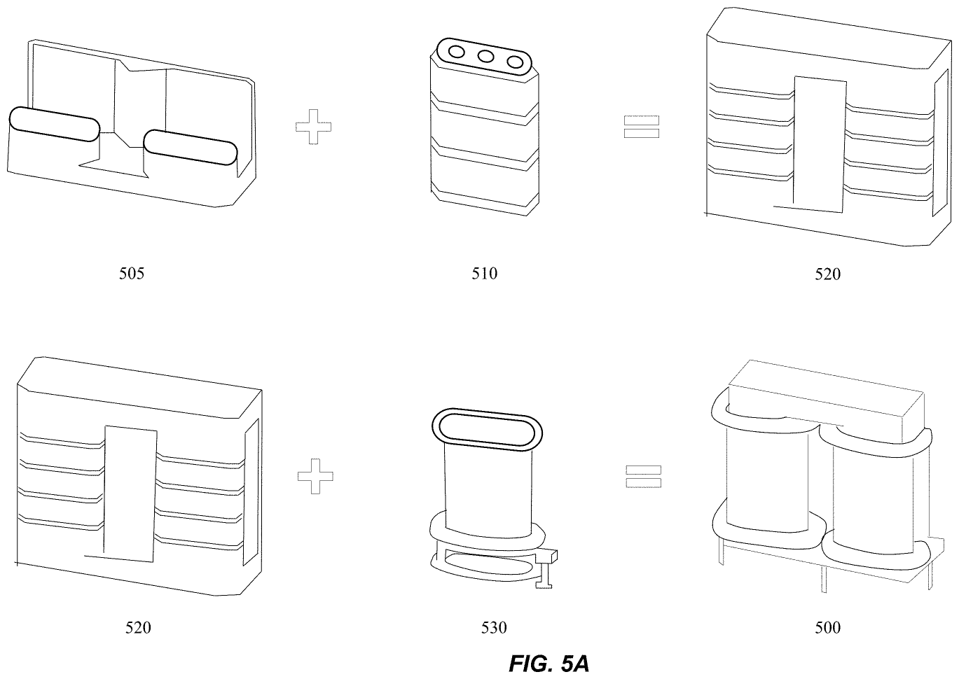

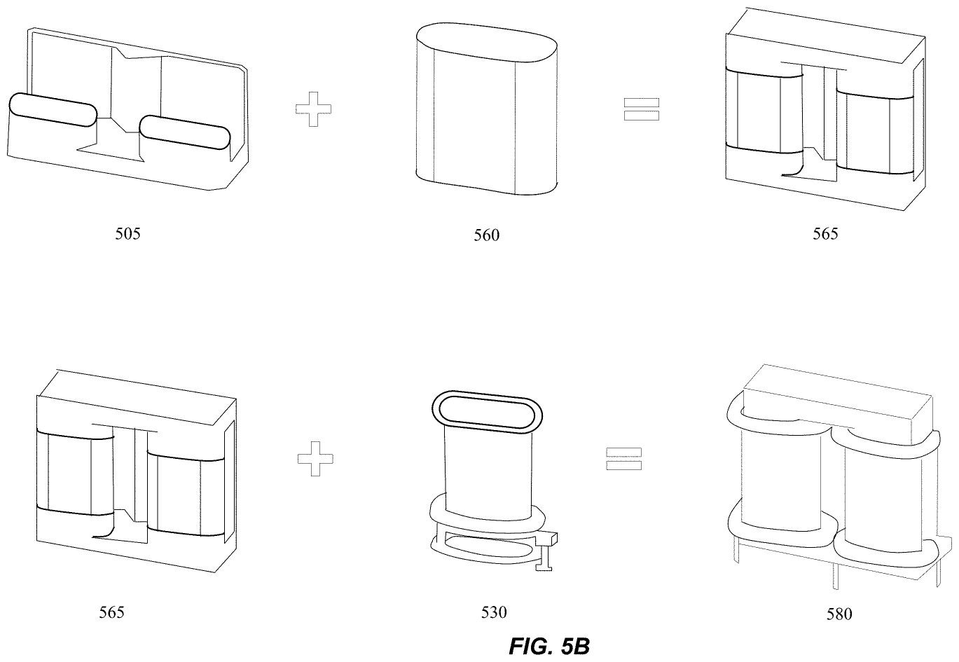

FIG. 5A is a block diagram of a transformer used in a conventional interleaved PFC booster converter circuit. As illustrated in FIG. 5A, the conventional interleaved PFC booster converter circuit 500 is the combination of ferrite core 505, the ferrite core and plate 510 and wire winding 30. Ferrite core 505 may include for example a Mn—Zn core. Ferrite core 505 includes gaps onto which the ferrite core and plate 510 are provided to provide a ferrite core with a ferrite core and plate 520. Wire windings 530 are provided around each of ferrite core and plate 510 to produce the conventional interleaved PFC booster converter circuit 500.

FIG. 5B is a block diagram of a transformer used in an interleaved PFC booster converter circuit according to an embodiment of the present disclosure. As illustrated in FIG. 5B, the interleaved PFC booster converter circuit 580 is the combination of the ferrite core 505, the metal powder core 560 and the wire winding 530. As illustrated in FIG. 5B, ferrite core 505 includes gaps provided on one side of the ferrite core 505. Metal powder cores 560 are positioned to occupy the gaps in the ferrite core 505 to provide a ferrite core with a metal powder cores 565. The metal powder cores 560 occupy a space no larger than the gaps of the ferrite core 505. Although two metal powder cores 560 are illustrated in the figure to be accommodated within the gaps of the ferrite core 505, more or fewer metal powder cores 505 can be used to be positioned within the gaps within the ferrite core 505 without departing from the spirit and scope of the present disclosure. Wire windings 530 are provided around each of the metal powder cores 560 to produce the interleaved PFC booster converter circuit 580.

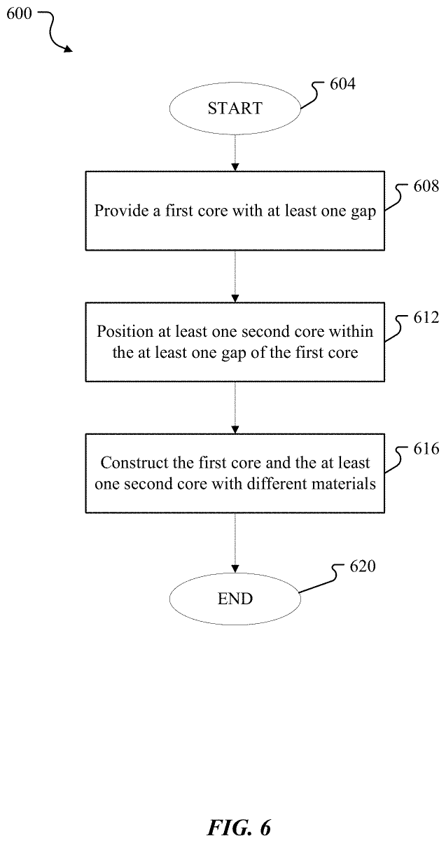

FIG. 6 is a flowchart of a manufacturing method for a magnetic core assembly in accordance with embodiments of the present disclosure. While a general order for the steps of the manufacturing method for a magnetic core assembly 600 is shown in FIG. 6, method 600 can include more or fewer steps or can arrange the order of the steps differently than those shown in FIG. 6. Further, two or more steps may be combined into one step. Generally, the method 600 starts with a START operation 604 and ends with an END operation 620.

Method 600 may START at START operation 604 and proceed to step 608 where a first core is provided with at least one gap. After providing the first core with at least one gap at step 608, method 600 proceeds to step 612 where at least one second core is positioned within the at least one gap of the first core. After at least one second core is positioned within the at least one gap of the first core at step 612, method 600 proceeds to step 616 where the first core and the at least one second core are constructed with different materials. After the first core and the at least one second core are constructed with different materials at step 616, method 600 may end at END operation 620.

Any of the steps, functions, and operations discussed herein can be performed continuously and automatically.

The exemplary systems and methods of this disclosure have been described in relation to a magnetic core assembly. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a magnetic core assembly. The magnetic core assembly includes a first core having at least one gap and at least one second core provided within the at least one gap of the first core. The first core and the at least one second core are made of different materials. Moreover, the at least one second core occupies a space no larger than the at least one gap of the first core.

Aspects of the above magnetic core assembly include the at least one second core includes a metal powder material.

Aspects of the above magnetic core assembly include the first core includes a ferrite material.

Aspects of the above magnetic core assembly include the at least one second core comprises an iron powder material selected from the group consisting of carbonyl iron, Fe—Si type, Fe—Ni type, Ni—Fe—Mo type and Fe—Si—Al type.

Aspects of the above magnetic core assembly include the first core comprises a material of Mn—Zn type.

Aspects of the above magnetic core assembly include the magnetic core assembly operates at an efficiency of at least 94%.

Aspects of the above magnetic core assembly include the first core occupies a volume greater than a volume of the at least one second core.

Embodiments include an electronic device. The electronic device includes a magnetic core and a coil wound around the magnetic core. The magnetic core includes a first core having at least one gap and at least one second core provided within the at least one gap of the first core. The first core and the at least one second core are made of different materials. Moreover, the at least one second core occupies a space no larger than the at least one gap of the first core.

Aspects of the above electronic device include the at least one second core includes a metal powder material.

Aspects of the above electronic device include the first core includes a ferrite material.

Aspects of the above electronic device include the at least one second core comprises an iron powder material selected from the group consisting of carbonyl iron, Fe—Si type, Fe—Ni type, Ni—Fe—Mo type and Fe—Si—Al type.

Aspects of the above electronic device include the first core comprises a material of Mn—Zn type.

Aspects of the above electronic device include the magnetic core assembly operates at an efficiency of at least 94%.

Aspects of the above electronic device include the first core occupies a volume greater than a volume of the at least one second core.

Aspects of the above electronic device include the electronic device is an inductor.

Aspects of the above electronic device include the electronic device is a transformer.

Embodiments include a manufacturing method for a magnetic core assembly. The manufacturing method for a magnetic core assembly includes providing a first core with at least one gap and positioning at least one second core within the at least one gap of the first core. The first core and the at least one second core are made of different materials. Moreover, the at least one second core occupies a space no larger than the at least one gap of the first core.

Aspects of the above manufacturing method for a magnetic core assembly include the at least one second core comprises an iron powder material selected from the group consisting of carbonyl iron, Fe—Si type, Fe—Ni type, Ni—Fe—Mo type and Fe—Si—Al type.

Aspects of the above manufacturing method for a magnetic core assembly include the first core comprises a material of Mn—Zn type.

Aspects of the above manufacturing method for a magnetic core assembly include the first core occupies a volume greater than a volume of the at least one second core.

Any one or more of the aspects/embodiments as substantially disclosed herein optionally in combination with any one or more other aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “determine,” “calculate,” “compute,” and variations thereof, as used herein, are used interchangeably and include any type of methodology, process, mathematical operation or technique.

What is claimed is:

1. A magnetic core assembly, comprising:
a first core having at least one gap; and
at least one second core provided within the at least one gap of the first core,
wherein the first core and the at least one second core are made of different materials, and
wherein the at least one second core occupies a space no larger than the at least one gap of the first core.

2. The magnetic core assembly of claim 1, wherein the at least one second core comprises a metal powder material.

3. The magnetic core assembly of claim 1, wherein the first core comprises a ferrite material.

4. The magnetic core assembly of claim 1, wherein the at least one second core comprises an iron powder material selected from the group consisting of carbonyl iron, Fe—Si type, Fe—Ni type, Ni—Fe—Mo type and Fe—Si—Al type.

5. The magnetic core assembly of claim 1, wherein the first core comprises a material of Mn—Zn type.

6. The magnetic core assembly of claim 1, wherein the magnetic core assembly operates at an efficiency of at least 94%.

7. The magnetic core assembly of claim 1, wherein the first core occupies a volume greater than a volume of the at least one second core.

8. An electronic device, comprising:
a magnetic core, comprising:
a first core having at least one gap; and
at least one second core provided within the at least one gap of the first core,
wherein the first core and the at least one second core are made of different materials, and
wherein the at least one second core occupies a space no larger than the at least one gap of the first core; and
a coil wound around the magnetic core.

9. The electronic device according to claim 8, wherein the at least one second core comprises a metal powder material.

10. The electronic device of claim 8, wherein the first core comprises a ferrite material.

11. The electronic device of claim 8, wherein the at least one second core comprises an iron powder material selected from the group consisting of carbonyl iron, Fe—Si type, Fe—Ni type, Ni—Fe—Mo type and Fe—Si—Al type.

12. The electronic device of claim 8, wherein the first core comprises a material of Mn—Zn type.

13. The electronic device of claim 8, wherein the magnetic core operates at an efficiency of at least 94%.

14. The electronic device of claim 8, wherein the first core occupies a volume greater than a volume of the at least one second core.

15. The electronic device of claim 8, wherein the electronic device is an inductor.

16. The electronic device of claim 8, wherein the electronic device is a transformer.

17. A manufacturing method for a magnetic core assembly comprising the steps of:
providing a first core with at least one gap;
positioning at least one second core within the at least one gap of the first core; and
construct the first core and the at least one second core with different materials,
wherein the at least one second core occupies a space no larger than the at least one gap of the first core.

18. The manufacturing method for a magnetic core assembly according to claim 17, wherein the at least one second core comprises an iron powder material selected from the group consisting of carbonyl iron, Fe—Si type, Fe—Ni type, Ni—Fe—Mo type and Fe—Si—Al type.

19. The manufacturing method for a magnetic core assembly according to claim 17, wherein the first core comprises a material of Mn—Zn type.

20. The manufacturing method for a magnetic core assembly according to claim 17, wherein the first core occupies a volume greater than a volume of the at least one second core.
